(19) United States
(12) Patent Application Publication
(10) Pub. No.: US 2017/0078269 A1
(43) Pub. Date: Mar. 16, 2017

(54) METHOD FOR MANAGING APPLICATION AND ELECTRONIC DEVICE SUPPORTING THE SAME

(71) Applicant: Samsung Electronics Co., Ltd., Suwon-si (KR)

(72) Inventors: Chan Kyu HAN, Seoul (KR); Kyung Hee LEE, Suwon-si (KR); Arnold YAU, Surray (GB); Yo Hwa KIM, Yongin-si (KR); Dong Hyun CHOI, Seoul (KR)

(21) Appl. No.: 15/263,896

(22) Filed: Sep. 13, 2016

(30) Foreign Application Priority Data
Sep. 15, 2015 (KR) 10-2015-0130427

(51) Int. Cl. H04L 29/06; H04L 9/32

(52) U.S. Cl. CPC H04L 63/0807; H04L 9/3247

(57) ABSTRACT

An electronic device and a method for managing an application is provided. The electronic device includes a communication module configured to communicate with an external device, a processor includes a normal module and a secure module, and a memory connected to the processor. The normal module of the processor is configured to receive an application package from the external device, and if a secure application is included in at least a portion of the application package, the processor is configured to control for installing the secure application in the memory associated with the secure module.

### CROSS-REFERENCE TO RELATED APPLICATION(S)

This application claims the benefit under 35 U.S.C. §119(a) of a Korean patent application filed on Sep. 15, 2015 in the Korean Intellectual Property Office and assigned Serial number 10-2015-0130427, the entire disclosure of which is hereby incorporated by reference.

### TECHNICAL FIELD

The present disclosure relates to a method for managing various kinds of applications and an electronic device supporting the same.

### BACKGROUND

An electronic device, such as a smart phone, a tablet or the like, performs various functions by using one or more applications. An application (hereinafter referred to as “app”) executed in the electronic device may require a variety of information depending on the execution of the app. Some apps provide information that is not related to secure information (e.g., personal information, payment information, or the like), and other some apps require management of a high security level that requires secure information, such as personal information, payment information, biometric recognition information, and the like.

A new technology (e.g., ARM® TrustZone® technology) in which a part of a processor of the related art is separated and used as a secure environment is applied to an environment in which an app (e.g., payment app, biometric information recognition app, or the like) (hereinafter referred to as “secure app”) that requires a relatively high security level is safely executed.

According to the related art, in order to process (e.g., install, update, delete, or the like) a secure app in a secure environment, an electronic device has to process the secure app by connecting to a trusted service manager (TSM) server, which forms a secure channel, with the secure environment.

According to the related art, since mobile terminal manufacturers build a TSM for each secure environment, the development cost increases and the third party developer has to develop and manage a separate secure app. In this case, the above-described scheme is inefficient in that it requires version synchronization(s) and development update(s).

In the case where the TSM server of the related art is used, a secure app is installed by forming a channel between a secure module and the TSM server that is an external device. According to the related art, it is difficult to establish a secure module around the TSM server, and it is inconvenient to process associated normal apps en bloc (all together or all at the same time).

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide an application managing method that processes (e.g., install, update, delete, or the like) a secure app, which is included in an app package received in a normal environment (or a normal module) through an open market (e.g., Google play, Apple app store®, or the like) instead of a trusted service manager (TSM) server, in a secure environment (or a secure module) through an authentication procedure and an electronic device supporting the same.

In accordance with an aspect of the present disclosure, an electronic device is provided. The electronic device includes a communication module configured to communicate with an external device, at least one processor comprising a normal module and a secure module, and a memory connected to the at least one processor, wherein the normal module is configured to receive an application package from the external device, and wherein, if a secure application is included in at least a portion of the application package, the at least one processor is further configured to install the secure application in the memory associated with the secure module.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates a network environment including an electronic device according to various embodiments of the present disclosure;

FIG. 2 is a configuration diagram of a processor and a memory according to various embodiments of the present disclosure;

FIG. 3 is a flow chart illustrating an example of a method for managing an application according to various embodiments of the present disclosure;

FIG. 4 is a flow chart describing an example of an authentication process according to various embodiments of the present disclosure;

FIG. 5 is a drawing illustrating a signal flow of an authentication process according to various embodiments of the present disclosure;

FIG. 6 illustrates various methods for implementing an app management module according to various embodiments of the present disclosure;

FIG. 7 is a flow chart illustrating an example of a procedure of deleting a secure app according to various embodiments of the present disclosure;

FIG. 8 is a flow chart illustrating an example of an authentication process using an audit token according to various embodiments of the present disclosure;

FIG. 9 is a diagram illustrating an electronic device in a network environment, according to various embodiments of the present disclosure;

FIG. 10 is a block diagram of an electronic device according to various embodiments of the present disclosure; and

FIG. 11 is a block diagram of a program module according to various embodiments of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In the disclosure disclosed herein, the expressions “have”, “may have”, “include” and “comprise”, or “may include” and “may comprise” used herein indicate existence of corresponding features (e.g., elements such as numeric values, functions, operations, or components) but do not exclude presence of additional features.

In the disclosure disclosed herein, the expressions “A or B”, “at least one of A or/and B”, or “one or more of A or/and B”, and the like used herein may include any and all combinations of one or more of the associated listed items. For example, the term “A or B”, “at least one of A and B”, or “at least one of A or B” may refer to all of the case (1) where at least one A is included, the case (2) where at least one B is included, or the case (3) where both of at least one A and at least one B are included.

The terms, such as “first”, “second”, and the like used herein may refer to various elements of various embodiments of the present disclosure, but do not limit the elements. For example, “a first user device” and “a second user device” may indicate different user devices regardless of the order or priority thereof For example, without departing the scope of the present disclosure, a first element may be referred to as a second element, and similarly, a second element may be referred to as a first element.

It will be understood that when an element (e.g., a first element) is referred to as being “(operatively or communicatively) coupled with/to” or “connected to” another element (e.g., a second element), it can be directly coupled with/to or connected to the other element or an intervening element (e.g., a third element) may be present. In contrast, when an element (e.g., a first element) is referred to as being “directly coupled with/to” or “directly connected to” another element (e.g., a second element), it should be understood that there are no intervening element (e.g., a third element).

According to the situation, the expression “configured to” used herein may be used as, for example, the expression “suitable for”, “having the capacity to”, “designed to”, “adapted to”, “made to”, or “capable of”. The term “configured to” must not mean only “specifically designed to” in hardware. Instead, the expression “a device configured to” may mean that the device is “capable of” operating together with another device or other components. For example, a “processor configured to (or set to) perform A, B, and C” may mean a dedicated processor (e.g., an embedded processor) for performing a corresponding operation or a generic-purpose processor (e.g., a central processing unit (CPU) or an application processor (AP) which performs corresponding operations by executing one or more software programs which are stored in a memory device.

All the terms used herein, which include technical or scientific terms, may have the same meaning that is generally understood by a person skilled in the art. It will be further understood that terms, which are defined in a dictionary and commonly used, should also be interpreted as is customary in the relevant related art and not in an idealized or overly formal detect unless expressly so defined herein in various embodiments of the present disclosure. In some cases, even if terms are terms which are defined in the specification, they may not be interpreted to exclude embodiments of the present disclosure.

For example, an electronic device according to various embodiments of the present disclosure may include at least one of smartphones, tablet personal computers (PCs), mobile phones, video telephones, electronic book readers, desktop PCs, laptop PCs, netbook computers, workstations, servers, personal digital assistants (PDAs), portable multimedia players (PMPs), Moving Picture Experts Group phase 1 or phase 2 (MPEG-1 or MPEG-2) audio layer 3 (MP3) players, mobile medical devices, cameras, or wearable devices. According to various embodiments, a wearable device may include at least one of an accessory type of a device (e.g., a timepiece, a ring, a bracelet, an anklet, a necklace, glasses, a contact lens, or a head-mounted-device (HMD)), one-piece fabric or clothes type of a device (e.g., electronic clothes), a body-attached type of a device (e.g., a skin pad or a tattoo), or a bio-implantable type of a device (e.g., implantable circuit).

According to an embodiment, the electronic devices may be home appliances. The home appliances may include at least one of, for example, televisions (TVs), digital versatile disc (DVD) players, audios, refrigerators, air conditioners, cleaners, ovens, microwave ovens, washing machines, air cleaners, set-top boxes, a home automation control panel, a security control panel, TV boxes (e.g., Samsung HomeSync™, Apple TV™, or Google TV™), game consoles (e.g., Xbox™ and PlayStation™), electronic dictionaries, electronic keys, camcorders, or electronic picture frames.

According to an embodiment, the photographing apparatus may include at least one of medical devices (e.g., various portable medical measurement devices (e.g., a blood glucose monitoring device, a heartbeat measuring device, a blood pressure measuring device, a body temperature measuring device, and the like)), a magnetic resonance angiography (MRA), a magnetic resonance imaging (MRI), a computed tomography (CT), scanners, and ultrasonic devices), navigation devices, global positioning system (GPS) receivers, event data recorders (EDRs), flight data recorders (FDRs), vehicle infotainment devices, electronic equipment for vessels (e.g., navigation systems and gyrocompasses), avionics, security devices, head units for vehicles, industrial or home robots, automatic teller's machines (ATMs), points of sales (POSs), or internet of things (e.g., light bulbs, various sensors, electric or gas meters, sprinkler devices, fire alarms, thermostats, street lamps, toasters, exercise equipment, hot water tanks, heaters, boilers, and the like).

According to an embodiment, the electronic devices may include at least one of parts of furniture or buildings/structures, electronic boards, electronic signature receiving devices, projectors, or various measuring instruments (e.g., water meters, electricity meters, gas meters, or wave meters, and the like). In the various embodiments of the present disclosure, the electronic device may be one of the above-described various devices or a combination thereof An electronic device according to an embodiment may be a flexible device. Furthermore, an electronic device according to an embodiment may not be limited to the above-described electronic devices and may include other electronic devices and new electronic devices according to the development of technologies.

Hereinafter, an electronic device according to the various embodiments of the present disclosure may be described with reference to the accompanying drawings. In this disclosure, the term “user” may refer to a person who uses an electronic device or may refer to a device (e.g., an artificial intelligence electronic device) that uses an electronic device.

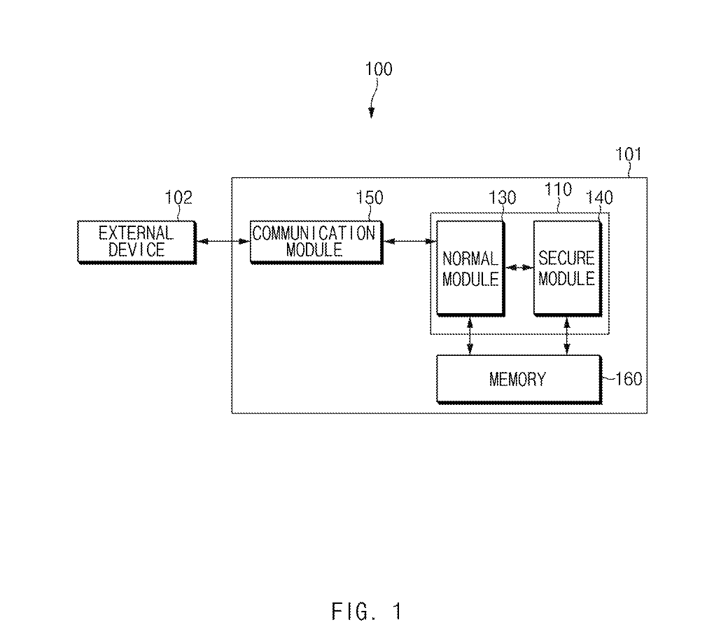

FIG. 1 illustrates a network environment including an electronic device according to various embodiments of the present disclosure.

Referring to FIG. 1, a network environment 100 may include an electronic device 101 and an external device 102.

The electronic device 101 may include a processor 110, a communication module 150, and a memory 160. The processor 110 may include one or more central processing units (CPUs), an application processor (AP), or a communication processor (CP). For example, the processor 110 may perform an arithmetic operation or data processing associated with control and/or communication of at least one of other elements of the electronic device 101.

According to various embodiments of the present disclosure, the processor 110 may include a normal module 130 and a secure module 140. The normal module 130 may perform arithmetic operations associated with processing of normal data that is not related to processing of secure data (e.g., payment information, personal information, and the like), and the secure module 140 may perform arithmetic operations associated with processing of secure data (e.g., payment information, personal information, and the like). For example, the normal module 130 may be a module that manages a rich execution environment (REE), and the secure module 140 may be a module that manages a trusted execution environment (TEE).

According to various embodiments of the present disclosure, the normal module 130 and the secure module 140 may be implemented to be separated from each other physically, to be separated from each other by software, or to be separated from each other physically and by software.

FIG. 1 illustrates an embodiment in which the processor 110 includes two modules (e.g., the normal module 130 and the secure module 140). However, embodiments of the present disclosure are not limited thereto. The processor may be divided into a plurality of environments (e.g., three or more environments (or modules)) based on security levels, and an app corresponding to a security level may be processed (e.g., installed, updated, deleted, or the like) in an environment corresponding to the security level. For example, in the case where the processor 110 includes first to third environments, an app of a first security level may be processed in the first environment, and apps of second and third security levels may be processed in the second and third environments. Below, embodiments will be described as the processor 110 includes the normal module 130 and the secure module 140. However, embodiments of the present disclosure are not limited thereto.

Referring to FIG. 1, the communication module 150 may perform communication with the external device 102. The communication module 150 may receive an app package for processing (e.g., installation, update, deletion, or the like) of an app (hereinafter referred to as “normal app”) that is installed on and executed by the normal module 130 or an app (hereinafter referred to as “secure app”) that is installed on and executed by the secure module 140. The communication module 150 may provide the received app package to the normal module 130.

The memory 160 may include a volatile and/or nonvolatile memory. The memory 160 may store instructions or data processed by the processor 110. According to various embodiments of the present disclosure, the memory 160 may store the app package received from the external device 102.

According to various embodiments of the present disclosure, the normal module 130 and the secure module 140 may access areas of the memory 160 which are different from each other. For example, an area of the memory 160 may be divided into two areas: a first area that is accessible by the normal module 130; and a second area that is accessible by the secure module 140. As another example, the memory 160 may include a first memory that is accessible by the normal module 130 and a second memory that is physically separated from the first memory and is accessible by the secure module 140. According to an embodiment, the secure module 140 may access the first memory that is managed by the normal module 130. For example, since the secure module 140 has a higher security level than the normal module 130, the secure module 140 may access both the first memory and the second memory.

The external device 102 may provide an app package for processing (e.g., installation, update, deletion, or the like) of a normal app or a secure app to the electronic device 101. For example, the external device 102 may be a server for an open market (e.g., Google Play™, Apple store®, or the like) and provide the electronic device 101 with an app package (e.g., an Android™ application package (APK) file) that includes installation data of a normal app and a secure app. The app package may be encrypted or signed in the manner specified by the normal module 130 or the secure module 140. The electronic device 101 may receive the app package through the communication module 150 and the normal module 130 and install the app package in a memory that is managed by the normal module 130 or the secure module 140 based on a kind of app (e.g., a normal app or a secure app).

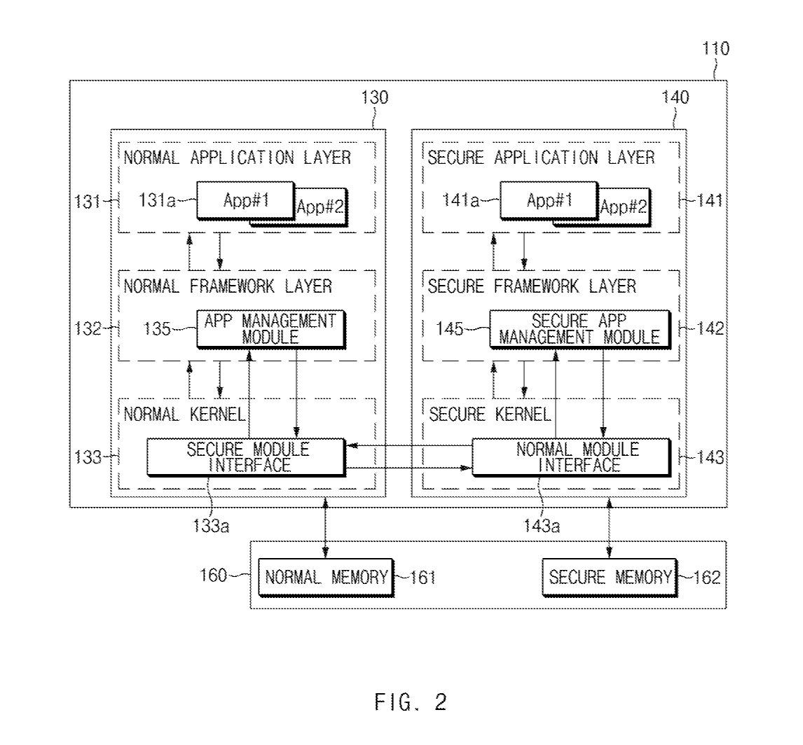

The electronic device 101 may freely download data (e.g., an APK file) associated with the processing of a secure app through a general open market (e.g., Google Play™, Apple app store®, or the like) and process the downloaded data with an associated normal app en bloc (all together or all at the same time). A method for processing or managing (e.g., installing, updating, deleting, or the like) apps of various security levels by the normal module 130 or the secure module 140 will be described in more detail with reference to FIGS. 2 to 11.

FIG. 2 is a configuration diagram of a processor and a memory according to various embodiments of the present disclosure.

FIG. 2 illustrates an embodiment in which the processor 110 includes the normal module 130 and the secure module 140. However, embodiments of the present disclosure are not limited thereto. For example, the processor 110 may include first to third modules, each of which performs a task associated with processing of an app of a specific security level (e.g., one of first to third security levels).

Referring to FIG. 2, the processor 110 may include the normal module 130 and the secure module 140.

The normal module 130 may perform arithmetic operations of a function associated with a normal operation of the electronic device 101. The normal module 130 may include a normal application layer 131, a normal framework layer 132, and a normal kernel 133.

The normal application layer 131 may include an operating system (OS) that controls resources associated with the electronic device 101 and/or various applications driven on the OS. At least one normal app 131a (e.g., payment, contact, e-mail, browser, or the like) running in the normal module 130 may utilize an application programming interface (API) (e.g., a functional API or a client API of the secure module 140) that is permitted to access the secure module 140.

The normal framework layer 132 may process one or more task requests received from the normal application layer 131 based on priorities. The normal framework layer 132 may perform the scheduling or the load balancing with respect to the one or more task requests by processing the one or more task requests based on the priorities. According to various embodiments of the present disclosure, the normal framework layer 132 may include a library that is needed for driving the normal module 130.

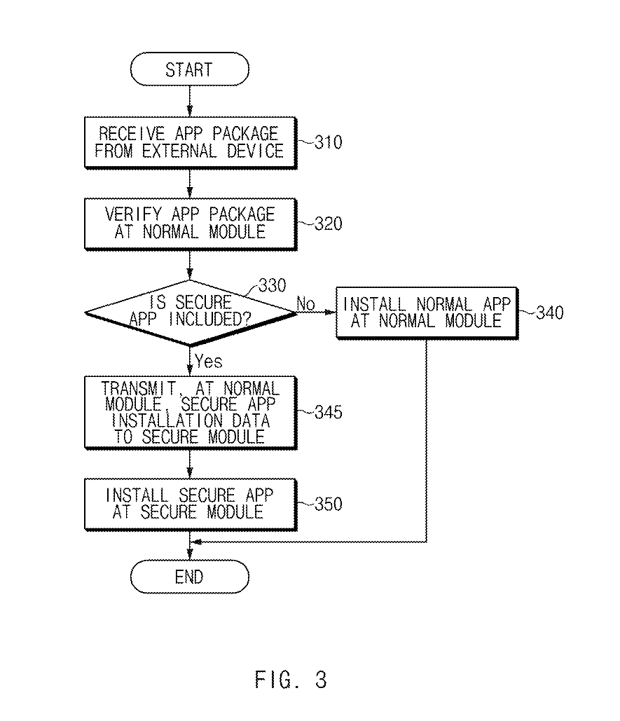

According to various embodiments of the present disclosure, the normal framework layer 132 may include an app management module 135. The app management module 135 may verify content of an app package received through the communication module 150 (shown in FIG. 1) and process normal app data or secure app data included in the app package. For example, in the case where the app package includes installation data of a secure app as well as installation data of a normal app, the app management module 135 may determine whether the app package includes the installation data of the secure app. The app management module 135 may perform a procedure (e.g., authentication process, provision of an installation file of the secure app, and the like) for installing the secure app in the secure module 140. Furthermore, the app management module 135 may process installation data of the normal app in the normal module 130. A process of handling the app package by the app management module 135 will be described in more detail with reference to FIGS. 3 to 8.

For example, the normal kernel 133 may control or manage system resources (e.g., the bus, the memory, or the like) that are used to execute operations or functions of other programs (e.g., the normal framework layer 132 or the normal application layer 131).

According to various embodiments of the present disclosure, the normal kernel 133 may include a secure module interface 133a for transmitting and receiving data to and from the secure module 140. The secure module interface 133a may provide a message to a normal module interface 143a of the secure module 140. The message may be delivered to only the secure module 140 in a hardware or software manner.

According to various embodiments of the present disclosure, the normal kernel 133 may access a normal memory 161 to record or load data in the normal memory 161. In contrast, the normal kernel 133 may be restricted from accessing a secure memory 162.

The secure module 140 may store and process data, which needs a relatively high security level, in a safe environment. The secure module 140 may operate on the processor 110 of the electronic device 101, that is, may operate based on a reliable hardware structure determined in manufacturing the electronic device 101. The secure module 140 may operate in a secure area when the application processor (AP) 110 or the memory 160 is divided into a general area and a secure area.

The secure module 140 may set software or hardware, which needs the security, to operate in only the secure area. The electronic device 101 may operate the secure module 140 through a physical change of hardware or a logical change of software. The secure module 140 may be separated from the normal module 130 through hardware support and may operate separately from the normal module 130 in a software manner in the same hardware.

To maintain/guarantee the security, the secure module 140 may process a task of a secure app, such as development, installation/deletion, operation execution, management, or the like, independently of the normal module 130. For the security, the secure module 140 may provide the following limited functions separately from the normal module 130: a separate software development toolkit (SDK); binary integrity verification; memory protection; protection of process independence; and resource separation.

The secure module 140 may include a secure application layer 141, a secure framework layer 142, and a secure kernel 143.

The secure application layer 141 may include an application that needs a relatively high security level unlike normal data. A secure app 141a executed in the secure application layer 141 may perform security-critical operations that need to be separated from the normal module 130. For example, the secure application layer 141 may include a payment app (on-line or off-line), a user authentication app (e.g., an app for biometric recognition such as fingerprint recognition, iris recognition, and the like).

The secure framework layer 142 may process one or more task requests received from the secure application layer 141 based on priorities. According to various embodiments of the present disclosure, the secure framework layer 142 may include a secure app management module 145. When the app management module 135 of the normal module 130 requests to authenticate data associated with a secure app, the secure app management module 145 may verify the validity of the data. Furthermore, the secure app management module 145 may execute secure app data, which is completely verified, in the secure module 140.

For example, the secure kernel 143 may control or manage system resources (e.g., the bus, the processor, the memory, or the like) that are used to execute operations or functions of other programs (e.g., the secure framework layer 142 or the secure application layer 141).

According to various embodiments of the present disclosure, the secure kernel 143 may include the normal module interface 143a for transmitting and receiving data to and from the normal module 130. The normal module interface 143a may exchange data with the secure module interface 133a of the normal module 130. For example, the normal module interface 143a may receive a specific message from the normal module 130. The normal module interface 143a of the secure module 140 may receive the message and provide the received message to a secure app (e.g., digital rights management (DRM), a secure payment module, a secure biometric information module, or the like) associated with the received message. The secure app may perform an operation associated with the message and may provide the operation result to the secure module interface 133a of the normal module 130 through the normal module interface 143a of the secure module 140. The secure module interface 133a of the normal module 130 may provide the operation result to at least one normal app that is operating in the normal module 130.

According to various embodiments of the present disclosure, the normal module 130 and the secure module 140 may be connected through a direct communication interface between layers respectively corresponding to the normal and secure modules 130 and 140. For example, the normal application layer 131 may include an interface for transmitting and receiving a message directly to and from the secure application layer 141. As another example, the normal framework layer 132 may include an interface for transmitting and receiving a message directly to and from the secure framework layer 142.

FIG. 3 is a flow chart illustrating an example of a method for managing an application according to various embodiments of the present disclosure. Below, the application managing method will be described under the condition that an app is installed. However, the application managing method may be applied to a process of updating an app.

Referring to FIG. 3, in operation 310, the electronic device 101 may receive an app package, which includes installation data of a normal app and a secure app, from an external device (e.g., the external device 102) through the normal module 130. The app package may be implemented in the format of a file (e.g., an APK file) provided in a general open market (e.g., Google Play™, Apple app store®, or the like). According to various embodiments of the present disclosure, the normal app and the secure app included in the app package may be apps that operate in conjunction with each other. For example, one package may include a normal app that provides user interface for mobile payment and a secure app that provides user payment information or fingerprint information in response to the request of the normal app. According to various embodiments of the present disclosure, the app package may further include additional information about the normal and secure apps included, such as a description, authentication information, or the like.

According to various embodiments of the present disclosure, operation 310 may be performed by the communication module 150. The communication module 150 may provide the received app package to the app management module 135 of the normal module 130.

According to various embodiments of the present disclosure, in the case where a specific normal app is installed in the normal module 130 or in the case where a secure app corresponding to the normal app is not installed, the electronic device 101 may request installation data of the secure app from the external device 102.

In operations 320 and 330, the normal module 130 may verify the app package to determine whether installation data of a secure app is included. According to various embodiments of the present disclosure, the normal module 130 may determine whether a secure app is included, by verifying content of an app package itself or by verifying additional information (e.g., header information) about the normal and secure apps included therein, such as a description, authentication information, or the like.

In operation 340, in the case where the app package does not include installation data of the secure app, the normal module 130 may install the normal app in the normal module 130 based on a method for installing the normal app.

In operation 345, in the case where the app package includes installation data of the secure app, the normal module 130 may transmit or send the installation data of the secure app to the secure module 140.

According to various embodiments of the present disclosure, operations 320 to 350 may be performed by the app management module 135 of the normal module 130. The app management module 135 may receive the app package from the communication module 150. In the case where the secure app is included in the app package, the app management module 135 may send installation data of the secure app to the secure app management module 145 of the secure module 140. According to various embodiments of the present disclosure, the installation data of the secure app may be sent the secure app management module 145 through an interface between the normal framework layer 132 of the normal module 130 and the secure framework layer 142 of the secure module 140.

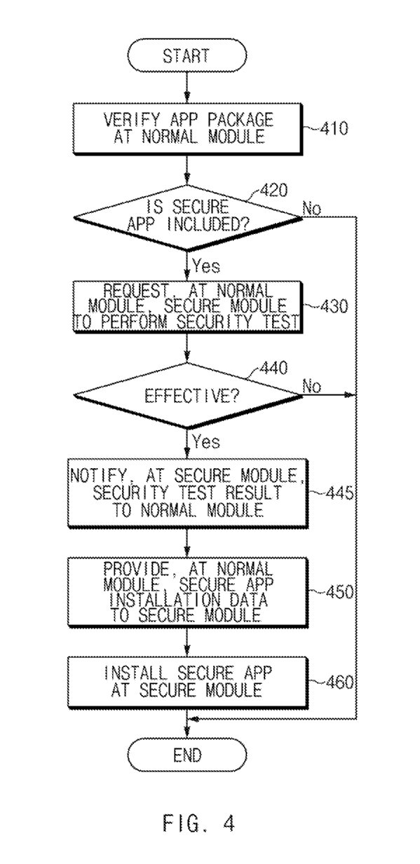

In operation 350, the secure module 140 may install the secure app by executing the installation data of the secure app received from the normal module 130. According to various embodiments of the present disclosure, the secure module 140 may install the secure app after performing a separate authentication process for verifying the integrity of installation data of the secure app. The authentication process will be described in more detail with reference to FIG. 4.

According to various embodiments of the present disclosure, the secure module 140 may associate a normal app corresponding to the installed secure app with the secure app. For example, the secure module 140 may link the installed secure app to the normal app. The linked secure app may be automatically executed when a user executes a normal app associated with the payment, and thus the payment information may be provided to the user or the payment authentication process may be performed. According to various embodiments of the present disclosure, the normal app may be installed through the app package that includes the secure app or may be installed before the installation of the secure app.

FIG. 4 is a flow chart describing an example of an authentication process according to various embodiments of the present disclosure.

Referring to FIG. 4, in operations 410 and 420, the normal module 130 may verify an app package received from the external device 102 to determine whether the app package includes a secure app. According to various embodiments of the present disclosure, the normal module 130 may perform a signature verification procedure for verifying the integrity of the received app package.

In operation 430, in the case where the secure app is included in the app package, the normal module 130 may request the secure module 140 to perform a security test with respect to installation data of the secure app. According to various embodiments of the present disclosure, the normal module 130 may provide the secure module 140 with an entirety or a portion of installation data of the secure app that is needed for the security test.

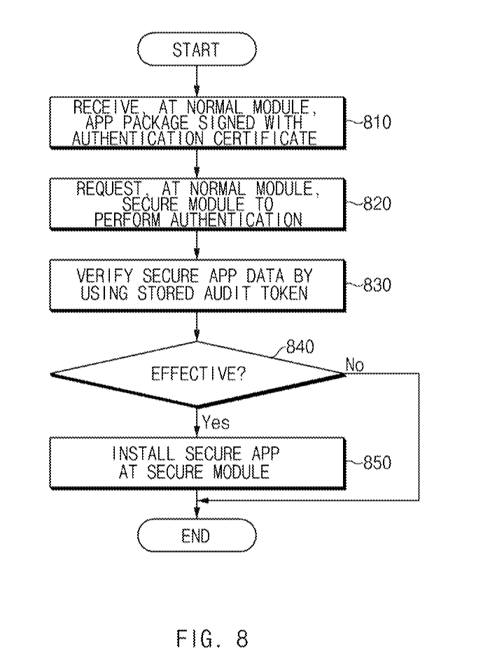

In operation 440, the secure module 140 may verify the validity (or effectiveness) of the data by performing the security test for verifying the integrity of the installation data of the secure app based on data provided from the normal module 130. Various encryption methods may be used for the security test. According to various embodiments of the present disclosure, the secure module 140 may perform the signature verification with respect to a secure app package or may perform the security test by using an audit token stored in advance. The audit token will be described in more detail with reference to FIG. 8.

In operations 445 and 450, in the case where the data is valid, the secure module 140 may notify the normal module 130 of the result. In the case where the data is valid, the normal module 130 may provide the secure module 140 with the installation data of the secure app.

In operation 460, the secure module 140 may install the secure app based on the installation data of the secure app.

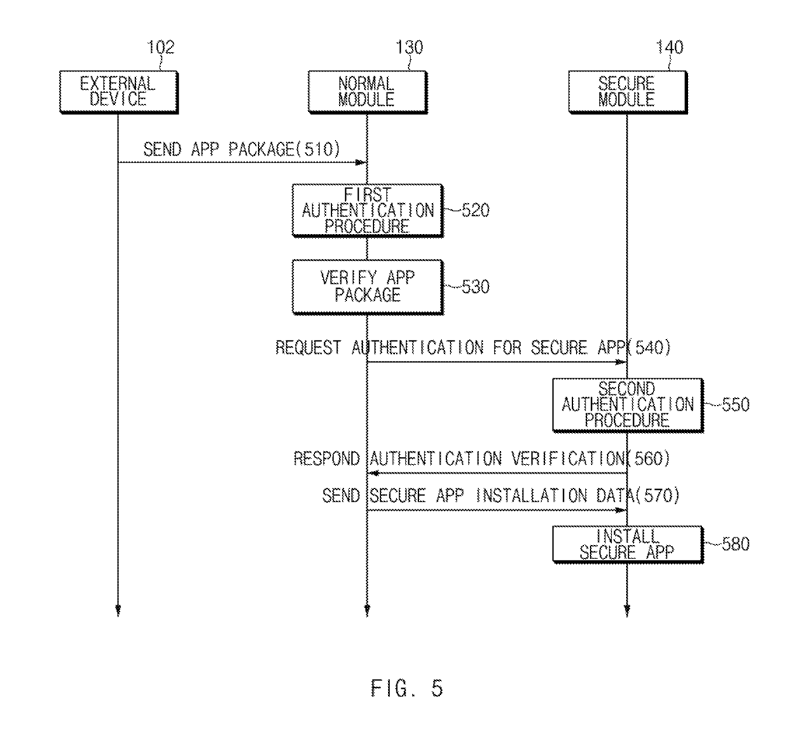

FIG. 5 is a drawing illustrating a signal flow of an authentication process according to various embodiments of the present disclosure.

Referring to FIG. 5, in operation 510, the external device 102 may provide the normal module 130 with an app package that includes installation data of a normal app and a secure app. The external device 102 may be a server for an open market (e.g., Google Play™, Apple app store®, or the like), and the app package may have a file of a specific format (e.g., an APK file).

In operation 520, the normal module 130 may verify the integrity of the app package through signature verification (a first authentication procedure). The first authentication procedure may be the same as or similar to a key signature verification process of a normal app.

In operation 530, in the case where the integrity of the app package is verified according to the first authentication procedure, whether the app package includes installation data of the secure app may be determined.

In operation 540, the normal module 130 may request the secure module 140 to authenticate data associated with the secure app. The normal module 130 may provide the secure module 140 with an entirety or a portion of installation data of the secure app that is needed for the security test.

In operation 550, the secure module 140 may perform the security test with respect to the portion of the installation data (a second authentication procedure). According to various embodiments of the present disclosure, the secure module 140 may perform the second authentication procedure by using an audit token stored in advance.

In operation 560, the secure module 140 may send the result of the second authentication procedure to the normal module 130.

In operations 570 and 580, in the case where the data of the secure app is determined as being valid, the normal module 130 may send the installation data of the secure app to the secure module 140. The secure module 140 may install the secure app.

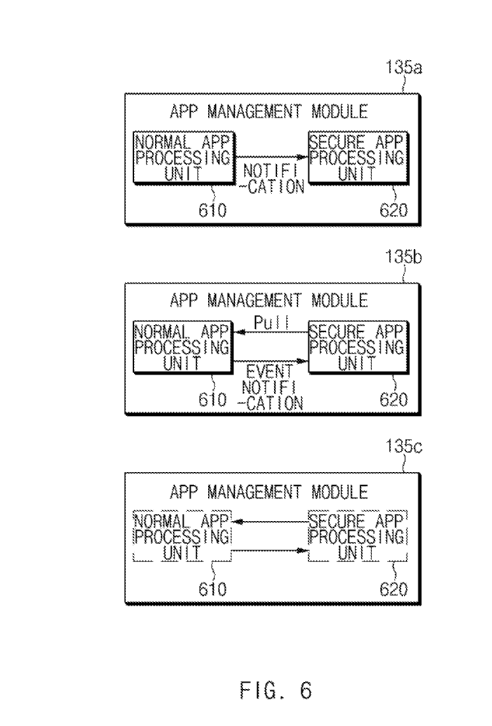

FIG. 6 illustrates various methods for implementing an app management module according to various embodiments of the present disclosure. In FIG. 6, an embodiment is exemplified as app management modules 135a, 135b, and 135c are implemented independently of each other. However, embodiments of the present disclosure are not limited thereto.

Referring to FIG. 6, the app management module 135a may include a normal app processing unit 610 and a secure app processing unit 620.

In the case where an app package is received through the communication module 150, the normal app processing unit 610 may determine whether a secure app is included in the received app package. Furthermore, the normal app processing unit 610 may process (e.g., install, update, delete, or the like) a normal app included in the app package.

In the case where installation data of the normal app is included in the app package, the normal app processing unit 610 may store the data in the normal memory 161 and execute the data. In the case where data of the secure app is included in the app package, the normal app processing unit 610 may notify (e.g., broadcast in Android™ OS) the secure app processing unit 620 that the data of the secure app is included the app package.

The secure app processing unit 620 may extract the data of the secure app from the app package in response to the notification. The secure app processing unit 620 may request the secure module 140 to authenticate the data of the secure app based on the extracted data. If the authentication task is completed and if the data is verified as valid data, the secure app processing unit 620 may provide the secure module 140 with installation data of the secure app. According to various embodiments of the present disclosure, the normal app processing unit 610 may be implemented through a package manager of the Android OS, and the secure app processing unit 620 may be implemented with an Android service.

According to various embodiments of the present disclosure, the secure app processing unit 620 of the app management module 135b may determine whether an event (e.g., a storage event of the app package including the secure app) is generated, through a pull service. In the case where the event that the app package including the secure app is stored is generated, the normal app processing unit 610 may provide notification that an event is generated.

According to various embodiments of the present disclosure, the normal app processing unit 610 and the secure app processing unit 620 may be integrated in the app management module 135c. The normal app processing unit 610 and the secure app processing unit 620 may not operate independently of each other but may operate as a single module.

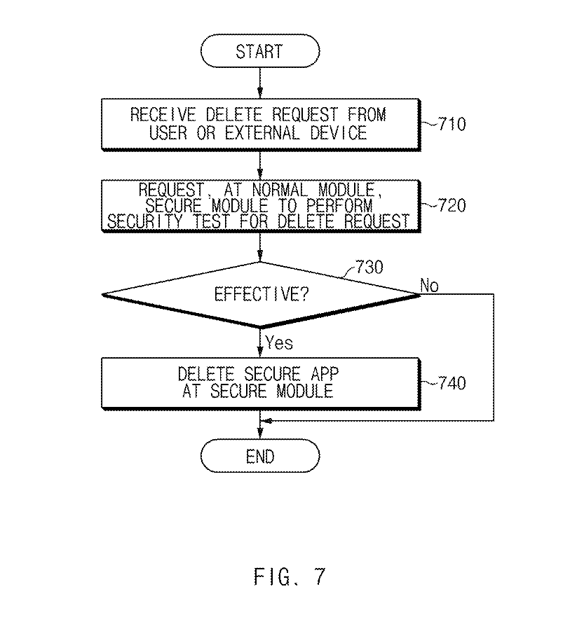

FIG. 7 is a flow chart illustrating an example of a procedure of deleting a secure app according to various embodiments of the present disclosure.

Referring to FIG. 7, in operation 710, the normal module 130 may receive a delete request of a secure app installed in the secure module 140 from a user or the external device 102. According to various embodiments of the present disclosure, in the case where a normal app is deleted from the normal module 130, a secure app associated with the normal app may be also deleted by a user request. The delete request may be performed by a method in which a user specifies an identifier of the secure app associated with the delete request or by a method in which the secure framework layer 142 of the secure module 140 verifies a secure app corresponding to the normal app.

In operation 720, the normal module 130 may request the secure module 140 to perform a security test corresponding to the delete request.

In operations 730 and 740, the secure module 140 may determine whether the delete request is valid, and if the delete request is valid, the secure module 140 may delete the secure app installed in the secure memory 162 that is managed by the secure module 140.

FIG. 8 is a flow chart illustrating an example of an authentication process using an audit token according to various embodiments of the present disclosure.

Referring to FIG. 8, the secure module 140 may store an audit token in the secure memory 162 in advance. The audit token may determine whether installation data of a secure app is generated by an app developer who has rights to manage the secure app. For example, the audit token may include authority identification information, status information, time information, or the like. The authority identification information may be an identifier of a company that generates the audit token. The status information may include a valid state, a blocked state, or a revoked state. The revoked state may involve a method for revoking a certificate. The time information may include information about the valid date of the audit token.

In operation 810, the normal module 130 may receive an app package signed with a specific certificate (e.g., an authenticated certificate or a certificate associated with the secure module 140). The app package may include a normal app and a secure app corresponding to the normal app. A developer who generates a secure app (or an app package including the secure app) may receive a certificate from a company that manages the secure module 140. The developer may sign the generated secure app with the certificate. The company that manages the secure module 140 may issue an audit token corresponding to each developer, and the issued audit token may be stored in the secure memory 162 that is accessible by the secure module 140. The audit token may be stored in a pre-load manner or may be updated through a separate app package.

In operation 820, the normal module 130 may request the secure module 140 to perform an authentication procedure based on authentication information included in the secure app.

In operations 830 and 840, the secure module 140 may verify the secure app data by using the stored audit token and may determine whether the data is valid, based on the verification result.

In operation 850, in the case where the secure app data is valid, the secure module 140 may install the secure app in the secure module 140. In contrast, in the case where the authentication certificate is blocked or revoked, the secure module 140 may notify the normal module 130 of a status of the certificate without installing the secure app.

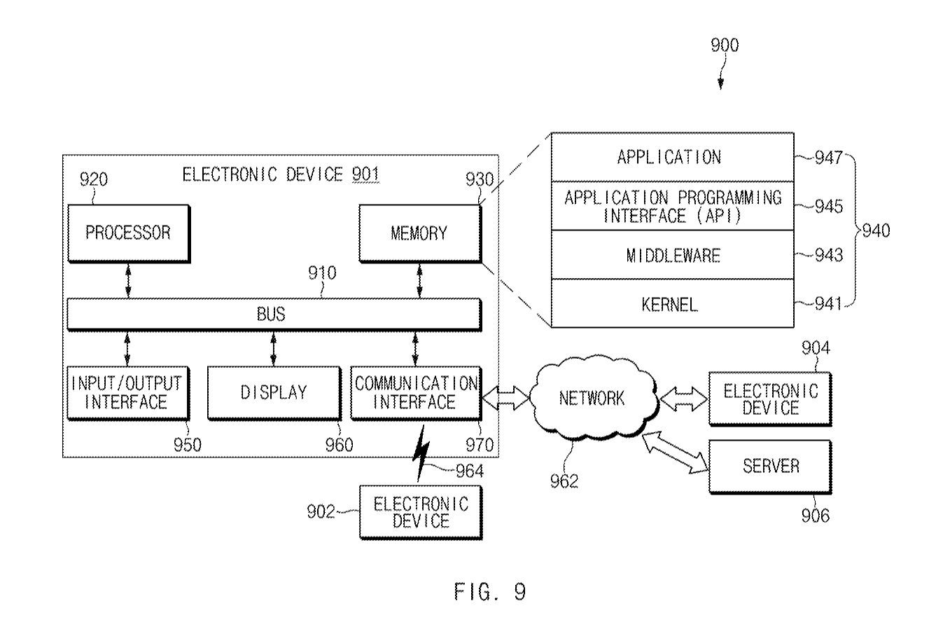

FIG. 9 is a diagram illustrating an electronic device in a network environment, according to various embodiments of the present disclosure.

Referring to FIG. 9, there is illustrated an electronic device 901 in a network environment 900 according to various embodiments of the present disclosure. The electronic device 901 may include a bus 910, a processor 920, a memory 930, an input/output (I/O) interface 950, a display 960, and a communication interface 970. According to an embodiment, the electronic device 901 may not include at least one of the above-described elements or may further include other element(s).

For example, the bus 910 may interconnect the above-described elements 920 to 970 and may include a circuit for conveying communications (e.g., a control message and/or data) among the above-described elements.

The processor 920 (e.g., the processor 110 shown in FIG. 1) may include one or more of a central processing unit (CPU), an application processor (AP), or a communication processor (CP). The processor 920 may perform, for example, data processing or an operation associated with control and/or communication of at least one other element(s) of the electronic device 901.

The memory 930 (e.g., the memory 160 shown in FIG. 1) may include a volatile and/or nonvolatile memory. For example, the memory 930 may store instructions or data associated with at least one other element(s) of the electronic device 901. According to an embodiment, the memory 930 may store software and/or a program 940. The program 940 may include, for example, a kernel 941, a middleware 943, an application programming interface (API) 945, and/or an application program (or “application”) 947. At least a part of the kernel 941, the middleware 943, or the API 945 may be called an “operating system (OS)”.

The kernel 941 may control or manage system resources (e.g., the bus 910, the processor 920, the memory 930, and the like) that are used to execute operations or functions of other programs (e.g., the middleware 943, the API 945, and the application program 947). Furthermore, the kernel 941 may provide an interface that allows the middleware 943, the API 945, or the application program 947 to access discrete elements of the electronic device 901 so as to control or manage system resources.

The middleware 943 may perform a mediation role such that the API 945 or the application program 947 communicates with the kernel 941 to exchange data.

Furthermore, with reference to FIG. 9, the middleware 943 may process one or more task requests received from the application program 947 according to a priority. For example, the middleware 943 may assign the priority, which makes it possible to use a system resource (e.g., the bus 910, the processor 920, the memory 930, or the like) of the electronic device 901, to at least one of the application program 947. For example, the middleware 943 may process the one or more task requests according to the priority assigned to the at least one, which makes it possible to perform scheduling or load balancing on the one or more task requests.

The API 945 may be an interface through which the application 947 controls a function provided by the kernel 941 or the middleware 943, and may include, for example, at least one interface or function (e.g., an instruction) for a file control, a window control, image processing, a character control, or the like.

The I/O interface 950 may transmit an instruction or data, input from a user or another external device, to other element(s) of the electronic device 901. Furthermore, the I/O interface 950 may output an instruction or data, received from other element(s) of the electronic device 901, to a user or another external device.

The display 960 may include, for example, a liquid crystal display (LCD), a light-emitting diode (LED) display, an organic LED (OLED) display, or a microelectromechanical systems (MEMS) display, or an electronic paper display. The display 960 may display, for example, various kinds of content (e.g., a text, an image, a video, an icon, a symbol, and the like) to a user. The display 960 may include a touch screen and may receive, for example, a touch, gesture, proximity, or hovering input using an electronic pen or a portion of a user's body.

The communication interface 970 may establish communication between the electronic device 901 and an external device (e.g., a first external electronic device 902, a second external electronic device 904, or a server 906). For example, the communication interface 970 may be connected to a network 962 through wireless communication or wired communication to communicate with an external device (e.g., the second external electronic device 904 or the server 906).

The wireless communication may include at least one of, for example, long-term evolution (LTE), LTE-advanced (LTE-A), code division multiple access (CDMA), wideband CDMA (WCDMA), universal mobile telecommunications system (UMTS), wireless broadband (WiBro), or global system for mobile communications (GSM), or the like, as cellular communication protocol. Furthermore, the wireless communication may include, for example, a local area network 964. The local area network 964 may include at least one of a wireless fidelity (Wi-Fi), a near field communication (NFC), or a global navigation satellite system (GNSS), or the like. The GNSS may include at least one of a global positioning system (GPS), a global navigation satellite system (GLONASS), BeiDou navigation satellite system (hereinafter referred to as “BeiDou”), the European global satellite-based navigation system (Galileo), or the like. In this specification, “GPS” and “GNSS” may be interchangeably used. The wired communication may include at least one of, for example, a universal serial bus (USB), a high definition multimedia interface (HDMI), a recommended standard-232 (RS-232), a plain old telephone service (POTS), or the like. The network 962 may include at least one of telecommunications networks, for example, a computer network (e.g., local area network (LAN) or wireless area network (WAN)), an internet, or a telephone network.

Each of the first and second external electronic devices 902 and 904 may be a device of which the type is different from or the same as that of the electronic device 901. According to an embodiment, the server 906 may include a group of one or more servers. According to various embodiments of the present disclosure, all or a portion of operations that the electronic device 901 will perform may be executed by another or plural electronic devices (e.g., the electronic devices 902 and 904 or the server 906). According to an embodiment, in the case where the electronic device 901 executes any function or service automatically or in response to a request, the electronic device 901 may not perform the function or the service internally, but, alternatively additionally, it may request at least a part of a function associated with the electronic device 101 at another device (e.g., the electronic device 902 or 904 or the server 906). The other electronic device (e.g., the electronic device 902 or 904 or the server 906) may execute the requested function or additional function and may transmit the execution result to the electronic device 901. The electronic device 901 may provide the requested function or service using the received result or may additionally process the received result to provide the requested function or service. To this end, for example, cloud computing, distributed computing, or client-server computing may be used.

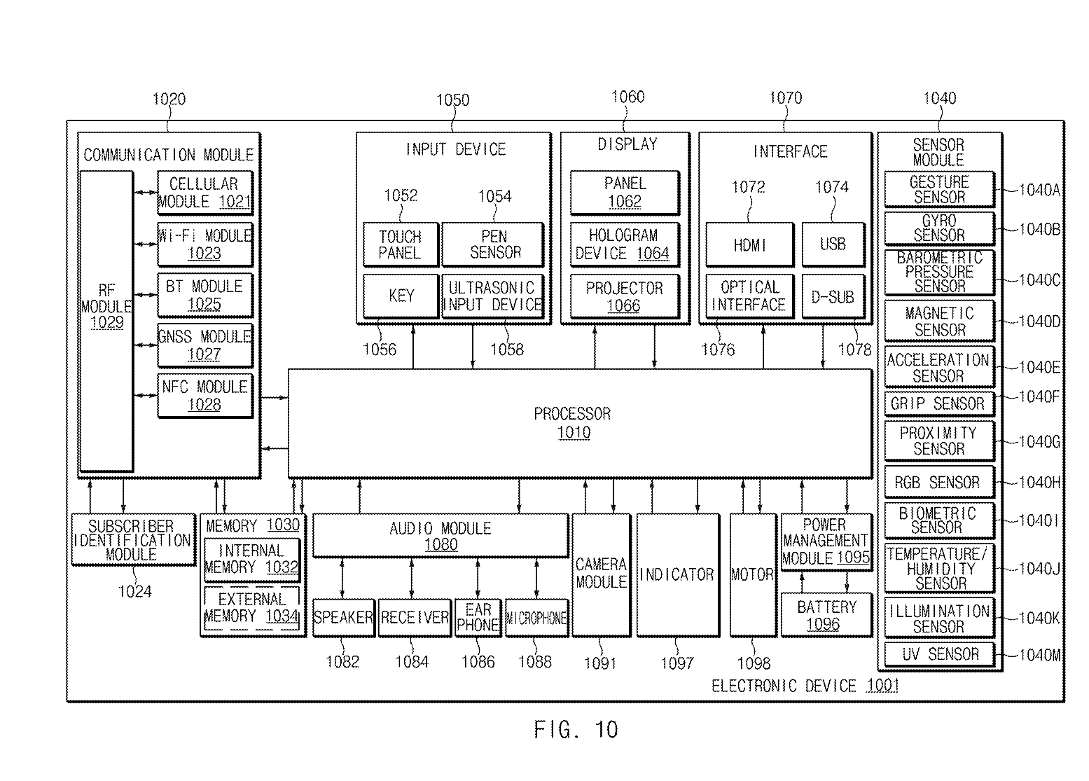

FIG. 10 is a block diagram of an electronic device according to various embodiments of the present disclosure. An electronic device 1001 may include, for example, all or a part of the electronic device 101 illustrated in FIG. 1. The electronic device 1001 may include one or more processors (e.g., an application processor (AP)) 1010, a communication module 1020, a subscriber identification module 1024, a memory 1030, a sensor module 1040, an input device 1050, a display 1060, an interface 1070, an audio module 1080, a camera module 1091, a power management module 1095, a battery 1096, an indicator 1097, and a motor 1098.

The processor 1010 may drive an operating system (OS) or an application to control a plurality of hardware or software elements connected to the processor 1010 and may process and compute a variety of data. The processor 1010 may be implemented with a system on chip (SoC), for example. According to an embodiment, the processor 1010 may further include a graphics processing unit (GPU) and/or an image signal processor. The processor 1010 may include at least a part (e.g., a cellular module 1021) of elements illustrated in FIG. 10. The processor 1010 may load and process an instruction or data, which is received from at least one of other elements (e.g., a nonvolatile memory) and may store a variety of data in a nonvolatile memory.

The communication module 1020 may be configured the same as or similar to the communication interface 970 of FIG. 9. The communication module 1020 may include a cellular module 1021, a Wi-Fi module 1023, a Bluetooth (BT) module 1025, a GNSS module 1027 (e.g., a GPS module, a GLONASS module, a BeiDou module, or a Galileo module), a near field communication (NFC) module 1028, and a radio frequency (RF) module 1029.

The cellular module 1021 may provide voice communication, video communication, a message service, an Internet service or the like through a communication network. According to an embodiment, the cellular module 1021 may perform discrimination and authentication of the electronic device 1001 within a communication network using the subscriber identification module 1024 (e.g., a subscriber identification module (SIM) card), for example. According to an embodiment, the cellular module 1021 may perform at least a portion of functions that the processor 1010 provides. According to an embodiment, the cellular module 1021 may include a communication processor (CP).

Each of the Wi-Fi module 1023, the BT module 1025, the GNSS module 1027, and the NFC module 1028 may include a processor for processing data exchanged through a corresponding module, for example. According to an embodiment, at least a part (e.g., two or more elements) of the cellular module 1021, the Wi-Fi module 1023, the BT module 1025, the GNSS module 1027, or the NFC module 1028 may be included within one integrated circuit (IC) or an IC package.

The RF module 1029 may transmit and receive, for example, a communication signal (e.g., an RF signal). The RF module 1029 may include, for example, a transceiver, a power amplifier module (PAM), a frequency filter, a low noise amplifier (LNA), an antenna, or the like. According to an embodiment, at least one of the cellular module 1021, the Wi-Fi module 1023, the BT module 1025, the GNSS module 1027, or the NFC module 1028 may transmit and receive an RF signal through a separate RF module.

The subscriber identification module 1024 may include, for example, a card and/or embedded SIM that includes a subscriber identification module and may include unique identify information (e.g., IC card identifier (ICCID)) or subscriber information (e.g., international mobile subscriber identity (IMSI)).

The memory 1030 (e.g., the memory 930) may include an internal memory 1032 or an external memory 1034. For example, the internal memory 1032 may include at least one of a volatile memory (e.g., a dynamic random access memory (DRAM), a static RAM (SRAM), or a synchronous DRAM (SDRAM)), a nonvolatile memory (e.g., a one-time programmable read only memory (OTPROM), a programmable ROM (PROM), an erasable and programmable ROM (EPROM), an electrically erasable and programmable ROM (EEPROM), a mask ROM, a flash ROM, a flash memory (e.g., a NAND flash memory, or a NOR flash memory), a hard drive, or a solid state drive (SSD).

The external memory 1034 may include a flash drive, for example, compact flash (CF), secure digital (SD), micro-SD, mini-SD, extreme digital (xD), multimedia card (MMC), a memory stick, or the like. The external memory 1034 may be functionally and/or physically connected with the electronic device 1001 through various interfaces.

The sensor module 1040 may measure, for example, a physical quantity or may detect an operation state of the electronic device 1001. The sensor module 1040 may convert the measured or detected information to an electric signal. The sensor module 1040 may include at least one of a gesture sensor 1040A, a gyro sensor 1040B, a barometric pressure sensor 1040C, a magnetic sensor 1040D, an acceleration sensor 1040E, a grip sensor 1040F, a proximity sensor 1040G, a color sensor 1040H (e.g., red, green, blue (RGB) sensor), a biometric sensor 1040I, a temperature/humidity sensor 1040J, an illuminance sensor 1040K, or an UV sensor 1040M. Even though not illustrated, additionally or alternatively, the sensor module 1040 may include, for example, an electronic nose (E-nose) sensor, an electromyography sensor (EMG) sensor, an electroencephalogram (EEG) sensor, an electrocardiogram (ECG) sensor, an infrared (IR) sensor, an iris sensor, and/or a fingerprint sensor. The sensor module 1040 may further include a control circuit for controlling at least one or more sensors included therein. According to an embodiment, the electronic device 1001 may further include a processor which is a part of the processor 1010 or independent of the processor 1010 and is configured to control the sensor module 1040. The processor may control the sensor module 1040 while the processor 1010 remains at a sleep state.

The input device 1050 may include, for example, a touch panel 1052, a digital stylus or (digital) pen sensor 954, a key 1056, or an ultrasonic input unit 1058. The touch panel 1052 may use at least one of capacitive, resistive, infrared and ultrasonic detecting methods. Also, the touch panel 1052 may further include a control circuit. The touch panel 1052 may further include a tactile layer to provide a tactile reaction to a user.

The (digital) pen sensor 1054 may be, for example, a portion of a touch panel or may include an additional sheet for recognition. The key 1056 may include, for example, a physical button, an optical key, a keypad, or the like. The ultrasonic input device 1058 may detect (or sense) an ultrasonic signal, which is generated from an input device, through a microphone (e.g., a microphone 1088) and may check data corresponding to the detected ultrasonic signal.

The display 1060 (e.g., the display 960) may include a panel 1062, a hologram device 1064, or a projector 1066. The panel 1062 may be configured the same as or similar to the display 960 of FIG. 9. The panel 1062 may be implemented to be flexible, transparent or wearable, for example. The panel 1062 and the touch panel 1052 may be integrated into a single module. The hologram device 1064 may display a stereoscopic image in a space using a light interference phenomenon. The projector 1066 may project light onto a screen so as to display an image. The screen may be arranged inside or outside the electronic device 1001. According to an embodiment, the display 1060 may further include a control circuit for controlling the panel 1062, the hologram device 1064, or the projector 1066.

Referring to FIG. 10, the interface 1070 may include, for example, a high-definition multimedia interface (HDMI) 1072, a universal serial bus (USB) 1074, an optical interface 1076, or a D-subminiature (D-sub) 1078. The interface 1070 may be included, for example, in the communication interface 970 illustrated in FIG. 9. Additionally or alternatively, the interface 1070 may include, for example, a mobile high definition link (MHL) interface, a SD card/multi-media card (MMC) interface, or an infrared data association (IrDA) standard interface.

The audio module 1080 may convert a sound and an electrical signal in dual directions. At least a part of the audio module 1080 may be included, for example, in the input/output interface 950 illustrated in FIG. 9. The audio module 1080 may process, for example, sound information that is input or output through a speaker 1082, a receiver 1084, an earphone 1086, or a microphone 1088.

The camera module 1091 for shooting a still image or a video may include, for example, at least one image sensor (e.g., a front sensor or a rear sensor), a lens, an image signal processor (ISP), or a flash (e.g., an LED or a xenon lamp).

The power management module 1095 may manage, for example, power of the electronic device 1001. According to an embodiment, a power management integrated circuit (PMIC) a charger IC, or a battery or fuel gauge may be included in the power management module 1095. The PMIC may have a wired charging method and/or a wireless charging method. The wireless charging method may include, for example, a magnetic resonance method, a magnetic induction method or an electromagnetic method and may further include an additional circuit, for example, a coil loop, a resonant circuit, a rectifier, or the like. The battery gauge may measure, for example, a remaining capacity of the battery 1096 and a voltage, current or temperature thereof while the battery is charged. The battery 1096 may include, for example, a rechargeable battery or a solar battery.

The indicator 1097 may display a specific state of the electronic device 1001 or a part thereof (e.g., the processor 1010), such as a booting state, a message state, a charging state, and the like. The motor 1098 may convert an electrical signal into a mechanical vibration and may generate a vibration effect, a haptic effect, or the like. Even though not illustrated, a processing device (e.g., a GPU) for supporting a mobile TV may be included in the electronic device 1001. The processing device for supporting a mobile TV may process media data according to the standards of digital multimedia broadcasting (DMB), digital video broadcasting (DVB), MediaFlo™, or the like.

Each of the above-mentioned elements may be configured with one or more components, and the names of the elements may be changed according to the type of the electronic device. The electronic device according to various embodiments of the present disclosure may include at least one of the above-mentioned elements, and some elements may be omitted or other additional elements may be added. Furthermore, some of the elements of the electronic device according to various embodiments of the present disclosure may be combined with each other so as to form one entity, so that the functions of the elements may be performed in the same manner as before the combination.

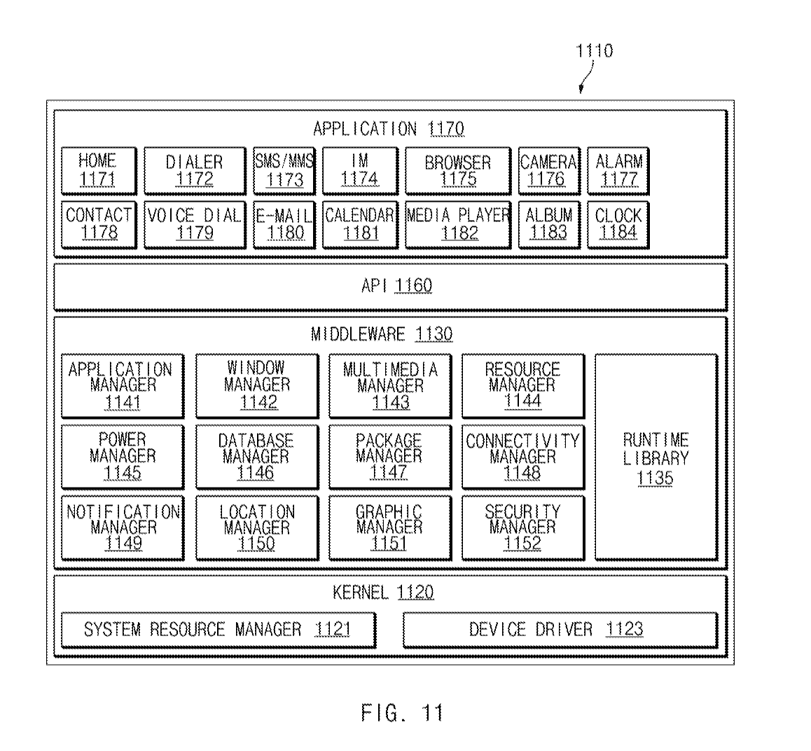

FIG. 11 is a block diagram of a program module according to various embodiments of the present disclosure. According to an embodiment, a program module 1110 (e.g., the program 940 shown in FIG. 9) may include an operating system (OS) to control resources associated with an electronic device (e.g., the electronic device 901) and/or diverse applications (e.g., the application program 947) driven on the OS. The OS may be, for example, Android™, iOS™, Windows™, Symbian®, Tizen®, or Bala®.

Referring to FIG. 11, the program module 1110 may include a kernel 1120, a middleware 1130, an application programming interface (API) 1160, and/or an application 1170. At least a part of the program module 1110 may be preloaded on an electronic device or may be downloadable from an external electronic device (e.g., the external device 102, and the like).

The kernel 1120 (e.g., the kernel 941 shown in FIG. 9) may include, for example, a system resource manager 1121 and/or a device driver 1123. The system resource manager 1121 may perform control, allocation, or retrieval of system resources. According to an embodiment, the system resource manager 1121 may include a process managing part, a memory managing part, or a file system managing part. The device driver 1123 may include, for example, a display driver, a camera driver, a Bluetooth (BT) driver, a shared memory driver, an USB driver, a keypad driver, a Wi-Fi driver, an audio driver, or an inter-process communication (IPC) driver.

The middleware 1130 may provide, for example, a function which the application 1170 needs in common, or may provide diverse functions to the application 1170 through the API 1160 to allow the application 1170 to efficiently use limited system resources of the electronic device. According to an embodiment, the middleware 1130 (e.g., the middleware 943) may include at least one of a runtime library 1135, an application manager 1141, a window manager 1142, a multimedia manager 1143, a resource manager 1144, a power manager 1145, a database manager 1146, a package manager 1147, a connectivity manager 1148, a notification manager 1149, a location manager 1150, a graphic manager 1151, or a security manager 1152.

The runtime library 1135 may include, for example, a library module which is used by a compiler to add a new function through a programming language while the application 1170 is being executed. The runtime library 1135 may perform input/output management, memory management, or capacities about arithmetic functions.

The application manager 1141 may manage, for example, a life cycle of at least one application of the application 1170. The window manager 1142 may manage a graphical user interface (GUI) resource which is used in a screen. The multimedia manager 1143 may identify a format necessary for playing diverse media files and may perform encoding or decoding of media files by using a codec suitable for the format. The resource manager 1144 may manage resources such as a storage space, memory, or source code of at least one application of the application 1170.

The power manager 1145 may operate, for example, with a basic input/output system (BIOS) to manage a battery or power and may provide power information for an operation of an electronic device. The database manager 1146 may generate, search for, or modify database which is to be used in at least one application of the application 1170. The package manager 1147 may install or update an application which is distributed in the form of a package file. According to various embodiments of the present disclosure, the package manager 1147 may configure the normal app processing unit 610 FIG. 6.

The connectivity manager 1148 may manage, for example, wireless connection such as Wi-Fi or BT. The notification manager 1149 may display or notify an event such as arrival message, appointment, or proximity notification in a mode that does not disturb a user. The location manager 1150 may manage location information of an electronic device. The graphic manager 1151 may manage a graphic effect that is provided to a user or manage a user interface relevant thereto. The security manager 1152 may provide a general security function necessary for system security or user authentication. According to an embodiment, in the case where an electronic device (e.g., the electronic device 101) includes a telephony function, the middleware 1130 may further include a telephony manager for managing a voice or video call function of the electronic device.

The middleware 1130 may include a middleware module that combines diverse functions of the above-described elements. The middleware 1130 may provide a module specialized to each OS kind to provide differentiated functions. Additionally, the middleware 1130 may remove a part of the preexisting elements, dynamically, or may add a new element thereto.

The API 1160 (e.g., the API 945) may be, for example, a set of programming functions and may be provided with a configuration which is variable depending on an OS. For example, in the case where an OS is the android or the iOS, it may be permissible to provide one API set per platform. In the case where an OS is the Tizen®, it may be permissible to provide two or more API sets per platform.

The application 1170 (e.g., the application program 947) may include, for example, one or more applications capable of providing functions for a home 1171, a dialer 1172, an short message service (SMS)/multimedia messaging service (MMS) 1173, an instant message (IM) 1174, a browser 1175, a camera 1176, an alarm 1177, a contact 1178, a voice dial 1179, an e-mail 1180, a calendar 1181, a media player 1182, an album 1183, and a clock 1184, or for offering health care (e.g., measuring an exercise quantity or blood sugar) or environment information (e.g., atmospheric pressure, humidity, or temperature).

According to an embodiment, the application 1170 may include an application (hereinafter referred to as “information exchanging application” for descriptive convenience) to support information exchange between the electronic device (e.g., the electronic device 901 shown in FIG. 9) and an external electronic device (e.g., the electronic device 902 or 904 shown in FIG. 9). The information exchanging application may include, for example, a notification relay application for transmitting specific information to the external electronic device, or a device management application for managing the external electronic device.

For example, the notification relay application may include a function of transmitting notification information, which arise from other applications (e.g., applications for SMS/MMS, e-mail, health care, or environmental information), to an external electronic device (e.g., the electronic device 902 or 904). Additionally, the notification relay application may receive, for example, notification information from an external electronic device and provide the notification information to a user.

The device management application may manage (e.g., install, delete, or update), for example, at least one function (e.g., turn-on/turn-off of an external electronic device itself (or a part of components) or adjustment of brightness (or resolution) of a display) of an external electronic device (e.g., the electronic device 902) which communicates with the electronic device, an application running in the external electronic device, or a service (e.g., a call service, a message service, or the like) provided from the external electronic device.

According to an embodiment, the application 1170 may include an application (e.g., a health care application of a mobile medical device, and the like) which is assigned in accordance with an attribute of the external electronic device (e.g., the electronic device 902). According to an embodiment, the application 1170 may include an application which is received from an external electronic device (e.g., the electronic device 902). According to an embodiment, the application 1170 may include a preloaded application or a third party application which is downloadable from a server. The element titles of the program module 1110 according to the embodiment may be modifiable depending on kinds of OSs.

According to various embodiments of the present disclosure, at least a part of the program module 1110 may be implemented by software, firmware, hardware, or a combination of two or more thereof At least a portion of the program module 1110 may be implemented (e.g., executed), for example, by the processor (e.g., the processor 910 shown in FIG. 9). At least a portion of the program module 1110 may include, for example, a module, a program, a routine, sets of instructions, or a process for performing one or more functions.

According to various embodiments of the present disclosure, an electronic device includes a communication module configured to communicate with an external device and a processor that may be divided into a normal module and a secure module to operate, wherein the normal module of the processor is configured to receive an application package from the external device, and wherein if a secure application is included in at least a portion of the application package, the processor is configured to install the secure application in a memory associated with the secure module. According to various embodiments, the application package may further include a normal application associated with the secure application.

According to various embodiments of the present disclosure, the normal module may be configured to install the normal application in a memory associated with the normal module. The normal module may be configured to request the secure module to perform an authentication procedure for the secure application based on authentication information included in the secure application. The secure module may be configured to receive information associated with the authentication information by using the normal module. The secure module may be configured to perform the authentication procedure by verifying a signature of the secure application or by using an audit token stored in advance. The audit token may include authority identification information, status information, time information, or a combination thereof If the authentication fails, the secure module may be configured to refrain from installing the secure application in the memory associated with the secure module.

According to various embodiments of the present disclosure, the memory may include a normal memory that is accessible by the normal module and a secure memory that is accessible by the secure module, wherein the normal memory and the secure memory are implemented with areas of a memory that are different from each other or are implemented with physically separated memories.

According to various embodiments of the present disclosure, an electronic device includes a communication module configured to communicate with an external device, a processor that may be divided into a first module and a second module to operate, and a memory configured to store data under control of the processor, wherein the first module is configured to receive an application package including a first application of a first security level and a second application of a second security level corresponding to the first application from the external device, wherein the first module is configured to install the first application in a first memory associated with the first module, and wherein the second module is configured to install the second application in a second memory associated with the second module.

According to various embodiments of the present disclosure, an attribute of the first module may be different from an attribute of the second module. The attribute may include at least one of a security level or a range to which a function is limited.

According to various embodiments of the present disclosure, the first module may be configured to request the second module to perform an authentication procedure for the second application based on authentication information included in the second application. The second module may be configured to receive information associated with the authentication information by using the first module. The second module may be configured to perform the authentication procedure by verifying a signature of the second application or by using an audit token stored in advance. The audit token may include authority identification information, status information, time information, or a combination thereof If the authentication fails, the second module may be configured to refrain from installing the second application in the second memory associated with the second module.

According to various embodiments of the present disclosure, an electronic device includes a communication module configured to communicate with an external device and a processor that may be divided into a first module and a second module to operate, wherein the first module is configured to drive a first application, wherein the first module is configured to receive an application package comprising a second application to be driven on the second module from the external device, wherein the second module is configured to install the second application in a memory associated with the second module, and wherein the second module is configured to associate the first application, which corresponds to the second application, with the second application.

The second module may be configured to link the first application to the second application. The first module may be configured to request the second module to perform an authentication procedure for the second application based on authentication information included in the second application.

The term “module” used in this disclosure may represent, for example, a unit including one or more combinations of hardware, software and firmware. For example, the term “module” may be interchangeably used with the terms “unit”, “logic”, “logical block”, “component” and “circuit”. The “module” may be a minimum unit of an integrated component or may be a part thereof The “module” may be a minimum unit for performing one or more functions or a part thereof. The “module” may be implemented mechanically or electronically. For example, the “module” may include at least one of an application-specific IC (ASIC) chip, a field-programmable gate array (FPGA), and a programmable-logic device for performing some operations, which are known or will be developed.

At least a portion of an apparatus (e.g., modules or functions thereof) or a method (e.g., operations) according to various embodiments of the present disclosure may be, for example, implemented by instructions stored in a computer-readable storage media in the form of a program module. The instruction, when executed by a processor (e.g., the processor 920 shown in FIG. 9), may cause the one or more processors to perform a function corresponding to the instruction. The computer-readable storage media, for example, may be the memory 930.

The computer-readable storage media according to various embodiments of the present disclosure may store a program for executing an operation in which a communication module receives an application package from an external device and provides the application package to a normal module of a processor, an operation in which the normal module determines whether a secure application is included in at least a portion of the application package, and an operation in which the secure module of the processor installs the secure application in the secure module or in a memory associated with the secure module.

The computer-readable storage media may include a hard disk, a floppy disk, a magnetic media (e.g., a magnetic tape), an optical media (e.g., a compact disc read only memory (CD-ROM) and a digital versatile disc (DVD)), a magneto-optical media (e.g., a floptical disk), and hardware devices (e.g., a read only memory (ROM), a random access memory (RAM), or a flash memory). Also, a program instruction may include not only a mechanical code such as things generated by a compiler but also a high-level language code executable on a computer using an interpreter. The above-mentioned hardware devices may be configured to operate as one or more software modules to perform operations according to various embodiments of the present disclosure, and vice versa.

Modules or program modules according to various embodiments of the present disclosure may include at least one or more of the above-mentioned elements, some of the above-mentioned elements may be omitted, or other additional elements may be further included therein. Operations executed by modules, program modules, or other elements according to various embodiments of the present disclosure may be executed by a successive method, a parallel method, a repeated method, or a heuristic method. Also, a part of operations may be executed in different sequences, omitted, or other operations may be added.

According to various embodiments of the present disclosure, an application managing method and an electronic device may install a secure application driven in a secure module together with a normal application through a normal module.

According to various embodiments of the present disclosure, the application managing method and the electronic device may determine the integrity of secure app-related data provided through the normal module by using an audit token-based authentication procedure.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. An electronic device comprising:
a communication module configured to communicate with an external device; at least one processor comprising a normal module and a secure module; and
a memory connected to the at least one processor,
wherein the normal module is configured to receive an application package from the external device, and
wherein, if a secure application is included in at least a portion of the application package, the at least one processor is configured to control for installing the secure application in the memory associated with the secure module.

2. The electronic device of claim 1,
wherein the application package further comprises a normal application associated with the secure application, and
wherein the normal module is further configured to install the normal application in a memory associated with the normal module.

3. The electronic device of claim 1, wherein the normal module is further configured to request the secure module to perform an authentication procedure for the secure application based on authentication information included in the secure application.

4. The electronic device of claim 3, wherein the secure module is configured to receive information associated with the authentication information by using the normal module.

5. The electronic device of claim 3, wherein the secure module is configured to perform the authentication procedure by verifying a signature of the secure application or by using an audit token stored in advance.

6. The electronic device of claim 5, wherein the audit token comprises authority identification information, status information, time information, or a combination thereof.

7. The electronic device of claim 3, wherein if the authentication procedure fails, the secure module is configured to refrain from installing the secure application in the memory associated with the secure module.

8. The electronic device of claim 1,
wherein the memory comprises:
a normal memory that is accessible by the normal module, and
a secure memory that is accessible by the secure module; and
wherein the normal memory and the secure memory are implemented with areas of a memory that are different from each other or are implemented with physically separated memories.

9. An electronic device comprising:
a communication module configured to communicate with an external device;
at least one processor comprising a first module and a second module; and
a memory configured to store data,
wherein the at least one processor is configured to control for storing data in the memory,
wherein the memory comprises a first memory and a second memory,
wherein the first module is configured to receive an application package comprising a first application of a first security level and a second application of a second security level corresponding to the first application from the external device,
wherein the first module is further configured to install the first application in the first memory associated with the first module, and
wherein the second module is configured to install the second application in the second memory associated with the second module.

10. The electronic device of claim 9, wherein an attribute of the first module is different from an attribute of the second module.

11. The electronic device of claim 10, wherein the attribute of the first module and the attribute of the second module each comprises at least one of a security level or a range to which a function is limited.

12. The electronic device of claim 9, wherein the first module is further configured to request the second module to perform an authentication procedure for the second application based on authentication information included in the second application.

13. The electronic device of claim 12, wherein the second module is further configured to receive information associated with the authentication information by using the first module.

14. The electronic device of claim 12, wherein the second module is further configured to perform the authentication procedure by verifying a signature of the second application or by using an audit token stored in advance.

15. The electronic device of claim 14, wherein the audit token comprises authority identification information, status information, time information, or a combination thereof.

16. The electronic device of claim 12, wherein if the authentication procedure fails, the second module is further configured to refrain from installing the second application in the second memory associated with the second module.

17. An electronic device comprising:
a communication module configured to communicate with an external device; and
at least one processor comprising a first module and a second module,
wherein the first module is configured to drive a first application,
wherein the first module is further configured to receive an application package comprising a second application to be driven on the second module from the external device,
wherein the second module is configured to install the second application in a memory associated with the second module, and
wherein the second module is further configured to associate the first application, which corresponds to the second application, with the second application.

18. The electronic device of claim 17, wherein the second module is further configured to link the first application to the second application.

19. The electronic device of claim 17, wherein the first module is further configured to request the second module to perform an authentication procedure for the second application based on authentication information included in the second application.

20. A non-transitory computer-readable recording medium having recorded thereon at least one program comprising commands, which, when executed by at least one processor, performs a method, the method comprising:
receiving, at a communication module, an application package from an external device and providing the received application package to a normal module of the at least one processor;
verifying, at the normal module, whether a secure application is included in at least a portion of the application package; and
installing, at a secure module of the at least one processor, the secure application in the secure module or in a memory associated with the secure module.
